(19) United States
(12) Patent Application Publication
(10) Pub. No.: US 2026/0170332 A1
(43) Pub. Date: Jun. 18, 2026

(54) OPTIMIZING THE TRANSMISSION OF SEMANTIC INFORMATION IN BIOCOMMUNICATION SYSTEMS

(71) Applicant: Altos Labs, Inc., Redwood City, CA (US)

(72) Inventors: Francesca RATTI, San Mateo, CA (US); Benjamin Albert YANG, San Francisco, CA (US); Cyril Oscar LAGGER, San Diego, CA (US); Achal MAHAJAN, San Mateo, CA (US); Ban WANG, Sunnyvale, CA (US); James H. KAUFMAN, San Jose, CA (US); Vishrawas GOPALAKRISHNAN, San Francisco, CA (US); Hana J. EL-SAMAD, El Cerrito, CA (US)

(21) Appl. No.: 19/462,796

(22) Filed: Jan. 28, 2026

Related U.S. Application Data
(63) Continuation of application No. PCT/US2024/040208, filed on Jul. 30, 2024.
(60) Provisional application No. 63/516,828, filed on Jul. 31, 2023.

(51) Int. Cl. G06N 3/08; H04B 13/00

(52) U.S. Cl. CPC G06N 3/08; H04B 13/00

(57) ABSTRACT

One embodiment sets forth a technique for managing communication in a biocommunication system. The technique includes generating a plurality of distributions of destination messages associated with a receiver in the biocommunication system. The technique also includes generating, via execution of a machine learning model based on the plurality of distributions of destination messages, (i) a plurality of distributions of source messages associated with a transmitter in the biocommunication system and (ii) a plurality of mutual information values between the plurality of distributions of source messages and the plurality of distributions of destination messages. The technique further includes determining a distribution of source messages that is in the plurality of distributions of source messages and associated with a mutual information value included in the plurality of mutual information values, and causing a source message sampled from the distribution of source messages to be transmitted by the transmitter to the receiver.

### CROSS-REFERENCE TO RELATED APPLICATIONS

This application is a continuation of the co-pending International Patent Application titled, “Optimizing the Transmission of Semantic Information in Biocommunication Systems,” filed on Jul. 30, 2024 and having Serial No. PCT/US2024/040208, which application claims the benefit of the U.S. Provisional Application titled “Optimizing the Transmission of Semantic Information in Biocommunication Systems,” filed on Jul. 31, 2023, and having Ser. No. 63/516,828. The subject matter of these related applications is hereby incorporated herein by reference in its entirety.

### BACKGROUND

### Field of the Various Embodiments

Embodiments of the present disclosure relate generally to machine learning and communications and, more specifically, to optimizing the transmission of semantic information in biocommunication systems.

### Description of the Related Art

Biocommunication refers to various types of communication that occur within and/or across biological systems. Biocommunication systems play a crucial role in various cellular processes, including (but not limited to) intercellular signaling, gene regulation, and cellular responses to environmental stimuli. For example, the nucleus of a cell may exchange information with organelles to orchestrate the expression of appropriate genetic programs. In another example, immune cells may use intercellular communication to detect and combat invading pathogens.

Traditional techniques for studying and optimizing biocommunication systems have focused on maximizing the amount of information transferred between a transmitter and a receiver, similar to the approach used in digital communication systems. However, maximizing information transfer in biological systems may lead to unnecessary energy consumption and/or the transmission and/or receipt of redundant messages. Instead, communication in biological systems can be better represented in the form of “semantic information” that emphasizes the meaningful content of transmitted information.

While limited work has been done in investigating semantic information in biocommunication systems composed of synthetic cells, these approaches do not relate semantic information to other information theory principles such as channel capacity. Additionally, current techniques can fail to account for the dynamic nature of biological systems, where the state of a receiver can change over time and cause subsequent messages to affect the receiver in a different way.

As the foregoing illustrates, what is needed in the art are more effective techniques for managing the transmission of information in biocommunication systems.

### SUMMARY

One embodiment of the present invention sets forth a technique for managing communication in a biocommunication system. The technique includes generating a first plurality of distributions of destination messages associated with a receiver in the biocommunication system. The technique also includes generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages. The technique further includes determining a first distribution of source messages that is included in the first plurality of distributions of source messages and is associated with a first mutual information value included in the first plurality of mutual information values, and causing a source message sampled from the first distribution of source messages to be transmitted by the transmitter to the receiver.

One technical advantage of the disclosed techniques relative to the prior art is the ability to reduce unnecessary information transmission in a biocommunication system without adversely impacting the functional integrity of the receiver in the biocommunication system. Consequently, the disclosed techniques can be used to reduce redundant communication in the biocommunication system and/or improve the energy efficiency of the biocommunication system, compared with conventional techniques that attempt to maximize the amount of information transferred between a transmitter and a receiver. Another technical advantage of the disclosed techniques is the ability to (i) relate semantic information to the channel capacity of the biocommunication system and (ii) model changes to the state of the receiver and/or changes to the effect of the source messages on the receiver. Accordingly, the disclosed techniques may be used to track, manage, and/or optimize information transfer in the biocommunication system more accurately than conventional approaches that fail to account for the dynamic nature of entities in biocommunication systems and/or relate information transfer to channel capacity. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the training engine and execution engine of FIG. 1, according to various embodiments.

FIG. 3 illustrates the operation of the training engine and execution engine of FIG. 1 with an example viability function, according to various embodiments.

FIG. 4 sets forth a flow diagram of method steps for performing semantic optimization in a biocommunication system, according to various embodiments.

FIG. 5 sets forth a flow diagram of method steps for performing information transfer maximization in a biocommunication system, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

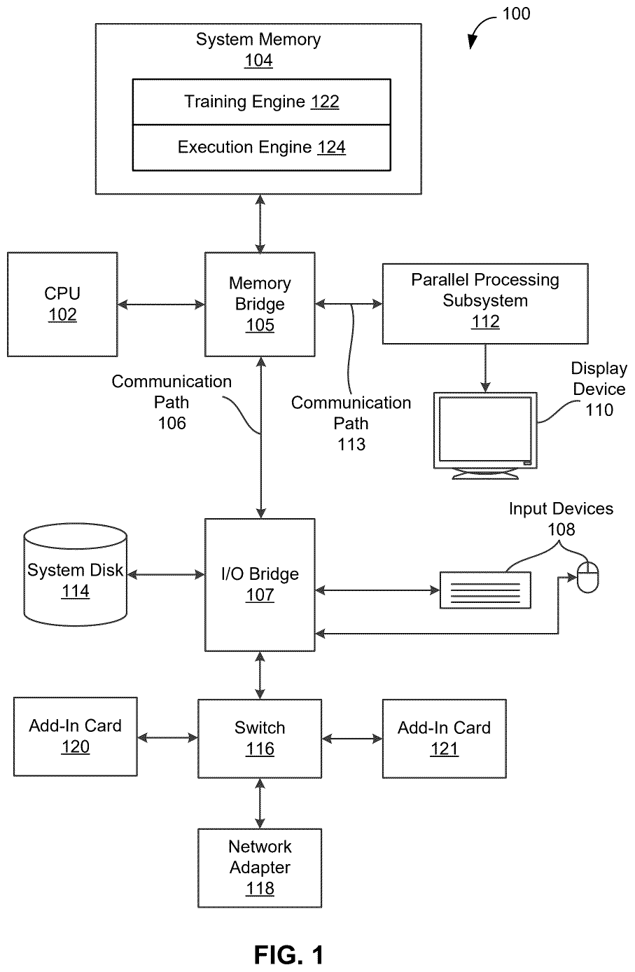

FIG. 1 is a block diagram illustrating a computer system 100 configured to implement one or more aspects of various embodiments. In one embodiment, computer system 100 includes a desktop computer, a laptop computer, a smart phone, a personal digital assistant (PDA), tablet computer, or any other type of computing device configured to receive input, process data, and optionally display images, and is suitable for practicing one or more embodiments. Computer system 100 also, or instead, includes a machine or processing node operating in a data center, cluster, or cloud computing environment that provides scalable computing resources (optionally as a service) over a network.

As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

Parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality of the system can be distributed across multiple nodes of a distributed and/or cloud computing system. Second, the connection topology, including the number and arrangement of bridges, the number of CPUs 102, and the number of parallel processing subsystems 112, can be modified as desired. For example, in some embodiments, system memory 104 may be connected to CPU 102 directly rather than through memory bridge 105, and other devices would communicate with system memory 104 via memory bridge 105 and CPU 102. In another example, parallel processing subsystem 112 may be connected to I/O bridge 107 or directly to CPU 102, rather than to memory bridge 105. In a third example, I/O bridge 107 and memory bridge 105 may be integrated into a single chip instead of existing as one or more discrete devices. Third one or more components shown in FIG. 1 may be omitted. For example, switch 116 may be eliminated, and network adapter 118 and add-in cards 120, 121 would connect directly to I/O bridge 107.

In one or more embodiments, computer system 100 is configured to execute a training engine 122 and an execution engine 124 that reside in system memory 104. Training engine 122 and execution engine 124 may be stored in system disk 114 and/or other storage and loaded into system memory 104 when executed.

More specifically, training engine 122 and execution engine 124 include functionality to optimize semantic information in a biocommunication system. In some embodiments, a biocommunication system includes a system of communication within or between biological entities. For example, training engine 122 and execution engine 124 may be used to infer, quantify, and/or improve cellular, genetic, molecular, electrical, tactile, visual, audio, and/or other types of communication pathways involving organelles, cells, tissues, organs, organisms, and/or other biological entities. The operation of training engine 122 and execution engine 124 is described in further detail below.

### Optimizing Semantic Information in Biocommunication Systems

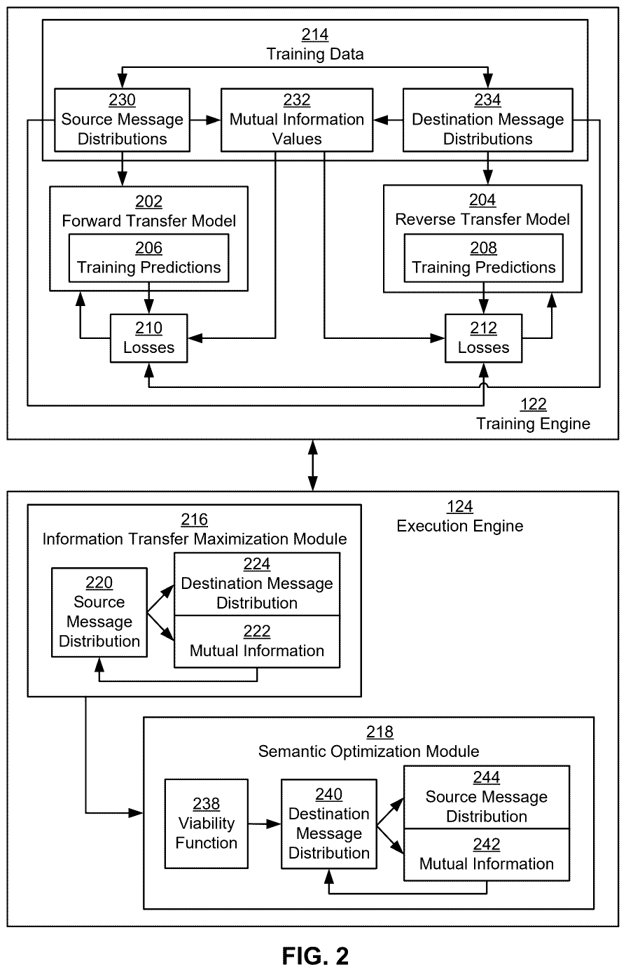

FIG. 2 is a more detailed illustration of training engine 122 and execution engine 124 of FIG. 1, according to various embodiments. As mentioned above, training engine 122 and execution engine 124 operate to characterize and/or optimize semantic information in a biocommunication system. For example, training engine 122 and execution engine 124 may be used to determine the minimum amount of information to be transmitted from a transmitter to a receiver in the biocommunication system to maintain a desired level of operational integrity in the receiver.

The transmitter and receiver can include various components and/or entities that are capable of interacting in a biological context. For example, the transmitter and/or receiver may include cells, sub-cellular structures (e.g., organelles), tissues, organs, organisms, external sources of information (e.g., drugs, medical devices, etc.), and/or other participants in a biocommunication system.

In one or more embodiments, the objective associated with semantic information includes the following representation:

$${I}_{semantic} ( X , Y ) = {min}_{P ( X )} I ( X , Y ) \qquad ( 1 )$$

$$s . t . 𝒱 is satisfied .$$

In the above equation, X is a random variable representing a source message from a transmitter, Y is a random variable representing a destination message at the receiver, P(X) is the distribution of sources messages from the transmitter, and V is a viability function 238 that quantifies the operational integrity (e.g., the ability of the receiver to maintain essential functions, perform an intended role, attain or maintain a certain state, etc.) in the receiver. Additionally, I(X, Y)=D_{KL}(P(X,Y)∥P(X)⊗P(Y)) is the mutual information between the two random variables, where D_{KL} is the Kullback-Leibler divergence and P(X)⊗P(Y) is the product of P(X) and the distribution of destination messages at the receiver P(Y).

In some embodiments, viability function 238 includes an entropy of the received message H(Y). For example, Equation 1 may be rewritten as the following:

$${I}_{semantic} ( X , Y ) = {min}_{P ( X )} I ( X , Y ) \qquad ( 2 )$$

$$s . t . H ( Y ) = {H}_{max} ( Y ) .$$

In the above equation, Hₘₐₓ(Y) corresponds to the entropy of Y when the mutual information between X and Y is maximized. In other words, viability function 238 indicates that the optimal entropy at the receiver Hₘₐₓ(Y) is achieved when channel capacity is achieved (i.e., when the channel between the transmitter and receiver conveys the maximum amount of reliable and/or meaningful information).

While viability function 238 is discussed herein with respect to entropy, it will be appreciated that other types of viability functions can be used. For example, viability function 238 may include (but is not limited to) gene expression, energetic constraints, and/or multiple objectives.

As shown in FIG. 2, execution engine 124 includes an information transfer maximization module 216 and a semantic optimization module 218. Information transfer maximization module 216 determines the maximum amount of mutual information 222 for a biocommunication system that corresponds to the entropy value Hₘₐₓ(Y) (or another viability function 238).

More specifically, information transfer maximization module 216 aims to maximize the mutual information I(X, Y) and use the result as a tight lower bound on the channel capacity. In one or more embodiments, the operation of information transfer maximization module 216 is represented by the following:

$${I}_{max} ( X , Y ) = {max}_{P ( X )} I ( X , Y ) = {max}_{P ( X )} H ( X ) - H ( X \vert Y ) \qquad ( 3 )$$

In the above equation, H(X) and (X|Y) are the marginal entropy of X and the conditional entropy of X given Y, respectively. These entropies can be derived from the corresponding probability distributions P(X) and P(X|Y). To maximize the mutual information, information transfer maximization module 216 uses a given source message distribution 220 P(X) to estimate a corresponding destination message distribution 224 P(Y) and a mutual information 222 between source message distribution 220 and destination message distribution 224. Information transfer maximization module 216 also uses an optimization technique to iteratively update source message distribution 220 with the objective of maximizing mutual information 222.

The optimization technique used by information transfer maximization module 216 to determine Iₘₐₓ(X, Y) can vary based on attributes associated with the transmitter, receiver, and/or information communicated between the transmitter and the receiver. For example, gradient-based optimization may be used to maximize the mutual information in high-dimensional and/or continuous optimization problems. In another example, derivative-free optimization may be used with non-differentiable and/or noisy objective functions.

Semantic optimization module 218 determines the minimum amount of mutual information 242 that results in H(Y)=Hₘₐₓ(Y). That is, semantic optimization module 218 aims to reduce the information transmitted between the transmitter and receiver while maintaining the operational integrity of the receiver (e.g., by sharing semantic information as represented by Equation 2).

In particular, semantic optimization module 218 uses a given destination message distribution 240 P(Y) to estimate a corresponding source message distribution 244 and a mutual information 242 between source message distribution 244 and destination message distribution 240. Semantic optimization module 218 begins with an initial solution that sets destination distribution 240 to a certain destination message distribution 244 Pₘₐₓ(Y) outputted by information transfer maximization module 216 (e.g., the destination message distribution that corresponds to the maximized mutual information 222). Semantic optimization module 218 also uses a hill-climbing and/or another type of optimization technique to iteratively update destination message distribution 240 with the objective of minimizing mutual information 242 while satisfying viability function 238. Semantic optimization module 218 continues this process until a local and/or global minimum of I(X, Y) that satisfies viability function 238 is reached. Semantic optimization module 218 then sets I_{semantic}(X, Y) to this local minimum and obtains the corresponding optimal source message distribution 244 P_{semantic}(X) that satisfies viability function 238 while reducing mutual information 242.

In one or more embodiments, information transfer maximization module 216 and semantic optimization module 218 operate using one or more machine learning models. These machine learning model(s) include a forward transfer model 202 and a reverse transfer model 204. Forward transfer model 202 and reverse transfer model 204 may include one or more feedforward neural networks (FFNs), deep neural networks (DNNs), and/or other types of neural network and/or machine learning architectures.

Training engine 122 uses a set of training data 214 to train forward transfer model 202 and reverse transfer model 204. As shown in FIG. 2, training data 214 includes multiple source message distributions 230 and multiple destination message distributions 234, where each source message distribution is paired with a corresponding destination message distribution. For example, source message distributions 230 may include distributions of source messages transmitted from a given transmitter (e.g., cell, organ, tissue, organism, medical device, drug, etc.), and destination message distributions 234 may include distributions of destination messages received at a corresponding receiver (e.g., cell, organ, tissue, organism, etc.). Each of source message distributions 230 may include a “histogram” of numeric and/or other values associated with a message (e.g., signal) emitted by the transmitter. Similarly, each of distribution message distributions 234 may include a “histogram” of numeric and/or other values associated with a message (e.g., signal) generated and/or received by the receiver in response to the message from the transmitter.

Training data 214 also includes mutual information values 232 between source message distributions 230 and the corresponding destination message distributions 234. Continuing with the above example, each of mutual information values 232 may be computed using one or more measures of divergence and/or distance between a histogram representing a given source message distribution (or another representation of the source message distribution) and a different histogram representing a corresponding destination message distribution (or another representation of the destination message distribution).

Training engine 122 trains forward transfer model 202 by inputting source message distributions 230 into forward transfer model 202. Training engine 122 executes forward transfer model 202 using the input to generate corresponding training predictions 206 that include predictions of (i) destination message distributions 234 paired with the inputted source message distributions 230 and (ii) mutual information values between the inputted source message distributions 230 and the corresponding destination message distributions 234. Training engine 122 computes one or more losses 210 using training predictions 206, mutual information values 232 associated with source message distributions 230 used to generate training predictions 206, and destination message distributions 234 associated with source message distributions 230 used to generate training predictions 206. For example, training engine 122 may compute losses 210 as a mean squared error (MSE) and/or another measure of the difference between training predictions 206 and the corresponding mutual information values 232 and/or destination message distributions 234. Training engine 122 then uses a training technique (e.g., gradient descent and backpropagation) to update parameters of forward transfer model 202 in a way that reduces losses 210. Thus, training engine 122 trains forward transfer model 202 to predict, for a given source message distribution associated with the transmitter, (i) a corresponding destination message distribution associated with the receiver and (ii) a mutual information between the source message distribution and destination message distribution.

Training engine 122 trains reverse transfer model 204 by inputting destination message distributions 234 into reverse transfer model 204. Training engine 122 executes reverse transfer model 204 using the input to generate corresponding training predictions 208 that include predictions of (i) source message distributions 230 paired with the inputted destination message distributions 234 and (ii) mutual information values between the inputted destination message distributions 234 and the corresponding source message distributions 230. Training engine 122 computes one or more losses 212 using training predictions 208, mutual information values 232 associated with destination message distributions 234 used to generate training predictions 206, and source message distributions 230 associated with destination message distributions 234 used to generate training predictions 208. For example, training engine 122 may compute losses 212 as a mean squared error (MSE) and/or another measure of the difference between training predictions 208 and the corresponding mutual information values 232 and/or source message distributions 230. Training engine 122 then uses a training technique (e.g., gradient descent and backpropagation) to update parameters of reverse transfer model 204 in a way that reduces losses 212. Thus, training engine 122 trains reverse transfer model 204 to predict, for a given destination message distribution associated with the receiver, (i) a corresponding source message distribution associated with the transmitter and (ii) a mutual information between the source message distribution and destination message distribution.

After forward transfer model 202 is trained, forward transfer model 202 can be used by information transfer maximization module 216 to generate a given source message distribution 220 that maximizes mutual information 222. More specifically, information transfer maximization module 216 can use the trained forward transfer model 202 to convert a given source message distribution 220 P(X) into predictions of a corresponding destination message distribution 224 P(Y) and a corresponding mutual information 222 I(X, Y) between source message distribution 220 and destination message distribution 224. Information transfer maximization module 216 may also use a “latent inceptionism” backpropagation technique to compute a gradient of I(X, Y) with respect to P(X). Information transfer maximization module 216 may additionally use a gradient ascent technique to update source message distribution 220 based on the computed gradient (e.g., by adding the gradient multiplied by a fixed learning rate to source message distribution 220). Information transfer maximization module 216 may repeat this process until mutual information 222 is maximized, a certain number of iterations has been performed, the change in mutual information 222 between consecutive iterations falls below a threshold, and/or another condition is met.

Information transfer maximization module 216 can also, or instead, omit the use of forward transfer model 202 in determining a given source message distribution 220 that maximizes mutual information 222. For example, information transfer maximization module 216 may use a family of distributions with a certain set of parameters to represent source message distribution 220 P(X). Information transfer maximization module 216 may also use a Covariance Matrix Adaptation Evolution Strategy (CMA-ES) and/or another gradient-free optimization technique to minimize a function corresponding to −I(X, Y) by iteratively updating a covariance matrix of a multivariate Gaussian distribution from which candidate solutions for P(X) are chosen. After P(X) has been updated, information transfer maximization module 216 may estimate the corresponding P(Y) and I(X, Y) using histograms. Information transfer maximization module 216 may repeat this process until mutual information 222 is maximized, a certain number of iterations has been performed, the change in mutual information 222 between consecutive iterations falls below a threshold, and/or another condition is met.

After information transfer maximization module 216 has finished maximizing mutual information 222, information transfer maximization module 216 determines the corresponding source message distribution 220 Pₘₐₓ(X) and destination message distribution 224 Pₘₐₓ(Y). Information transfer maximization module 216 also uses Pₘₐₓ(Y) to calculate Hₘₐₓ(Y) for use by semantic optimization module 218.

After reverse transfer model 204 is trained, reverse transfer model 204 can be used by semantic optimization module 218 to generate a given destination message distribution 240 that minimizes mutual information 242 while satisfying viability function 238. More specifically, semantic optimization module 218 may begin by setting destination message distribution 240 to Pₘₐₓ(Y) and viability function 238 to Hₘₐₓ(Y). Semantic optimization module 218 may use the trained reverse transfer model 204 to convert destination message distribution 240 into predictions of a corresponding source message distribution 244 P(X) and a corresponding mutual information 242 I(X, Y) between source message distribution 244 and destination message distribution 240. Semantic optimization module 218 may also use a hill climbing technique and/or another type of optimization technique to iteratively update destination message distribution 240 in a way that maintains H(Y)=Hₘₐₓ(Y) specified in viability function 238. Semantic optimization module 218 may repeat this process until mutual information 242 is minimized while satisfying viability function 238, a certain number of iterations has been performed, the change in mutual information 242 between consecutive iterations falls below a threshold, and/or another condition is met.

After semantic optimization module 218 has identified a given source message distribution 244 that results in the minimum mutual information 242 that satisfies viability function 238, execution engine 124 can use source message distribution 244 to conduct and/or manage subsequent communication between the transmitter and receiver. For example, execution engine 124 could construct a biocommunication system that utilizes samples from the determined source message distribution 244 to optimize for efficiency between the transmitter and receiver. Execution engine 124 could also, or instead, use the determined source message distribution 244 to perform experiments and/or interventions involving the biocommunication system.

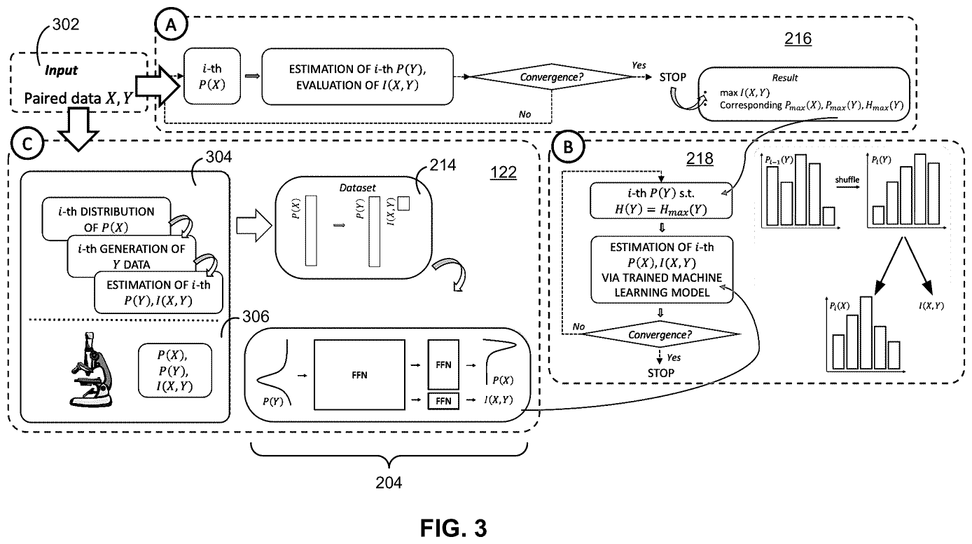

FIG. 3 illustrates the operation of training engine 122 and execution engine 124 of FIG. 1 with an example viability function 238, according to various embodiments. More specifically, FIG. 3 shows the operation of training engine 122 and execution engine 124 in optimizing communication between a transmitter and a receiver in a biocommunication system using a given viability function 238 of H(Y)=Hₘₐₓ(Y).

As shown in FIG. 3, training engine 122 and execution engine 124 operate using paired data 302 that includes pairs of source messages X and corresponding destination messages Y. Training engine 122 uses one or more sets of experiments 304 and/or 306 associated with this paired data 302 to generate source message distributions 230, destination message distributions 234, and mutual information values 232 in training data 214.

In some embodiments, training engine 122 performs one or more in-silico experiments 304 to simulate the transmission of source messages from one or more transmitters and the generation of corresponding destination messages at one or more receivers. Training engine 122 can use the results of experiments 304 to iteratively convert the source messages into i source message distributions 230, determine i corresponding destination messages for each source message distribution (e.g., by sampling a set of source messages from the source message distribution and simulating the generation of a set of corresponding destination messages), and estimate i corresponding destination message distributions 234 and mutual information values 232.

Training engine 122 can also, or instead, use the results of one or more in-vitro and/or in-vivo experiments 306 to determine values associated with source messages from one or more transmitters and corresponding destination messages at one or more receivers. Training engine 122 can use the measured values to generate source message distributions 230, destination message distributions 234, and mutual information values 232. After source message distributions 230, destination message distributions 234, and mutual information values 232 are generated via experiments 304 and/or 306 and/or results of experiments 304 and/or 306, training engine 122 populates one or more sets of training data 214 with examples that include pairs of source message distributions 230 and destination message distributions 234 and mutual information values 232 between the paired source message distributions 230 and destination message distributions 234.

Training engine 122 uses training data 214 to train reverse transfer model 204, as discussed above. While not illustrated in FIG. 3, training engine 122 can also use training data 214 to train forward transfer model 202, as discussed above.

Execution engine 124 uses the trained reverse transfer model 204 and/or forward transfer model 202 to execute information transfer maximization module 216 and semantic optimization module 218. As shown in FIG. 3, information transfer maximization module 216 uses forward transfer model 202 and/or another technique to convert a given source message distribution 220 into estimates of a corresponding destination message distribution 224 and mutual information 222. Information transfer maximization module 216 also determines whether or not convergence has been reached by mutual information 222 (e.g., whether or not mutual information 222 has been maximized). While convergence is not reached, information transfer maximization module 216 uses an optimization technique to iteratively update source message distribution 220 in a way that increases mutual information 222 with a corresponding destination message distribution 224. After convergence is reached, information transfer maximization module 216 generates a result that includes the maximized mutual information 222 Iₘₐₓ(X, Y) and the corresponding source message distribution 220, destination message distribution 224 Pₘₐₓ(Y), and entropy Hₘₐₓ(Y).

Semantic optimization module 218 uses the result generated by information transfer maximization module 216 to optimize for semantic communication that minimizes the transmission of unnecessary information from the transmitter to the receiver while ensuring that meaningful information is still communicated from the transmitter to the receiver. In particular, semantic optimization module 218 sets viability function 238 to H(Y)=Hₘₐₓ(Y) and an initial destination message distribution 240 to Pₘₐₓ(Y). Semantic optimization module 218 uses reverse transfer model 204 and/or another technique to convert destination message distribution 240 into estimated values for a corresponding source message distribution 244 and mutual information 242. Semantic optimization module 218 also determines whether or not convergence has been reached (e.g., whether or not mutual information 242 has been minimized while satisfying viability function 238).

While convergence is not reached, semantic optimization module 218 uses an optimization technique to iteratively update destination message distribution 240 in a way that reduces mutual information 242 while satisfying viability function 238. For example, semantic optimization module 218 may “shuffle” bins in a histogram corresponding to a given destination message distribution 240 to generate a new destination message distribution 240 for the next iteration that maintains viability function 238. Semantic optimization module 218 may convert the new destination message distribution 240 into a corresponding source message distribution 244 and mutual information 242 and determine whether or not convergence is reached. After convergence is reached, semantic optimization module 218 outputs source message distribution 244 associated with the lowest mutual information 242 that satisfies viability function 238 and/or uses that source message distribution 244 to conduct and/or manage communication between the transmitter and receiver.

The operation of training engine 122 and execution engine 124 can be illustrated using the following example use cases. A first example use case involves the use of training engine 122 and execution engine 124 to engineer a cell-cell communication system that includes the LuxR-LUXI-based circuit found in E. coli bacteria. The system includes a first E. coli cell that functions as a transmitter and a second E. coli cell that functions as a receiver. The system uses the concentration of Isopropyl β-d-1thiogalactopyranoside (IPTG) as the source message X from the transmitter cell, with varying concentrations representing different symbols in the source alphabet. Concentration-Shift Keying (CSK) modulation is used to modulate a destination message Y that is produced by the receiver cell and is represented by a range of Green Fluorescent Protein (GFP) concentration values.

A series of stochastic time simulations is used to populate a three-dimensional (3D) tensor with paired data X, Y. This paired data is processed by removing the time dimension for both X and Y, such that IPTG concentration is determined at the time of concentration injection t₀ and GFP concentration is determined as the value at steady state. A two-dimensional (2D) matrix for each of X and Y is populated with corresponding concentration values. Each column of the X matrix includes a certain number of equally spaced IPTG concentrations that are independently simulated, where each IPTG concentration in this range defines an individual data point. Each row of the X matrix represents the number of stochastic simulations conducted at a corresponding IPTG concentration. These simulations are used to assess the behavior and variability associated with each X in the dataset. A corresponding Y dataset is similarly generated and used to populate the Y matrix. Each cell of the Y matrix corresponds to a GFP concentration at the receiver cell that is generated in response to the IPTG concentration stored in the same cell of the X matrix. Each column of the X matrix is used to populate a histogram representing a source message distribution P(X), and each column of the Y matrix is used to populate a histogram representing a corresponding destination message distribution P(Y).

In the first example use case, information transfer maximization module 216 uses the family of Beta-Binomial distributions B(a, b), a, b>0 to parameterize source message distribution 220 P(X). Parameters of this distribution are then chosen to maximize mutual information 222 I(X, Y). Because the mutual information function is characterized implicitly with respect to the input distribution parameters, a derivative-free optimization technique of CMA-ES is used to optimize the mutual information. The mutual information maximization (i.e., the minimization of −I(X, Y) during the CMA-ES iterations) is performed as a function of the distribution parameters a and b to obtain the maximal mutual information and the corresponding input probability mass function (pmf) P(X). For each iteration of the algorithm, pairs of input/output data are generated for each candidate P(X), and both P(Y) and P(X|Y) are estimated from the data using histograms. Each P(X) is also transformed into a histogram to reduce the dimensionality of the support for the input data X. At convergence, Iₘₐₓ(X, Y) and the corresponding Pₘₐₓ(X) and Pₘₐₓ(Y) are obtained and used to calculate Hₘₐₓ(Y).

Semantic optimization module 218 uses the output of information transfer maximization module 216 to initialize viability function 238 and destination message distribution 240. Semantic optimization module 218 uses a hill climbing technique to iterate over values of P(Y) that satisfy H(Y)=Hₘₐₓ(Y) until mutual information 242 is minimized and convergence is reached.

When the support for Y is greater than 2, the number of distributions with the same entropy is infinite, which causes exploration of all possible distributions using an iterative technique to become computationally infeasible. Consequently, the hill climbing technique is restricted to iterate over the subset of distributions corresponding to the permutations of Pₘₐₓ(Y) by randomly swapping two y values at each iteration. This can be mathematically expressed as:

$${P}_{i} ( Y ) ∈ {𝒫}_{2}^{{P}_{i - 1} ( Y )} \qquad ( 4 )$$

where

$${𝒫}_{2}^{{P}_{i - 1} ( Y )}$$

represents the set or permutations of two values in Pᵢ₋₁(Y). This technique is initialized with Pᵢ₌₀(Y)=Pₘₐₓ(Y).

Additionally, when the support for Y is greater than 2, it is possible to encounter situations where the entropy remains constant, but the mutual information becomes zero. This would allow even a random signal to result in an optimal output entropy Hₒₚₜ(Y)=Hₘₐₓ(Y). To address this undesirable scenario, an early-stopping criterion and/or an additional regularization on the optimization objective can be used. A set of solutions for different mutual information values can also be provided throughout the optimization procedure, and a specific MI value can be selected based on specific system demands. For example, a lower MI may be associated with less energy consumed during transmission and less dependence of Y on X.

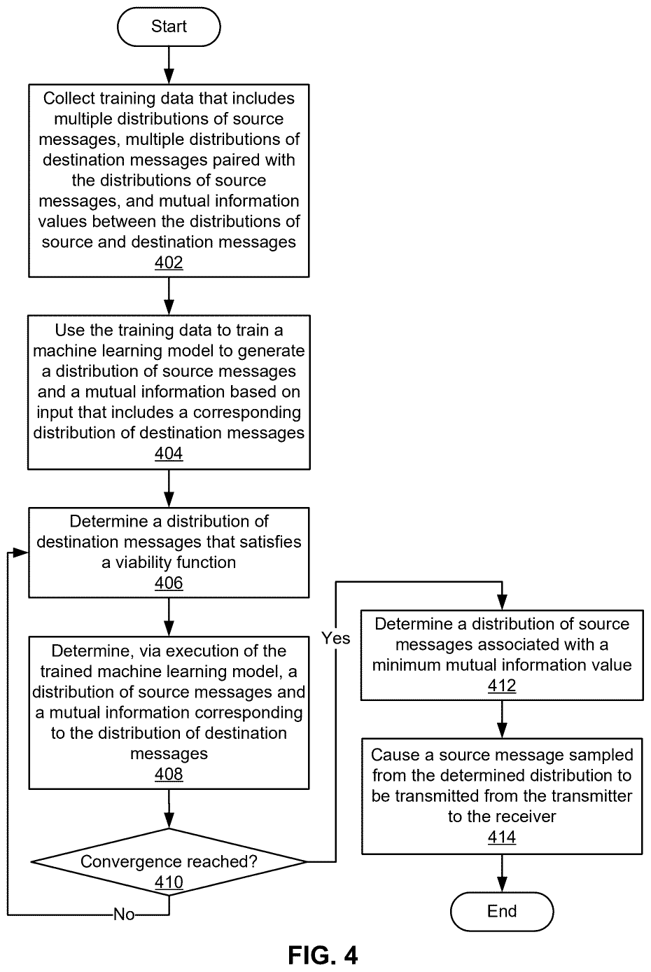

FIG. 4 sets forth a flow diagram of method steps for performing semantic optimization in a biocommunication system, according to various embodiments. Although the method steps are described in conjunction with the systems of FIGS. 1-3, persons skilled in the art will understand that any system configured to perform some or all of the method steps in any order falls within the scope of the present disclosure.

As shown, in step 402, training engine 122 collects training data that includes multiple distributions of source messages, multiple distributions of destination messages paired with the distributions of source messages, and mutual information values between the distributions of source messages and distributions of destination messages. For example, training engine 122 may collect and/or generate the training data using in-vitro, in-vivo, and/or in-silico experiments. In various embodiments, the training data can be image-based data, sequencing-based data, omics data, physiological data, data collected from steady state cells, data collected from perturbed cells, data from a young system, data from an older system, and/or other types of biological and/or signal data.

Each distribution of source messages can correspond to signals transmitted by a transmitter in the biocommunication system, and each distribution of destination messages can correspond to signals received by a corresponding receiver in the biocommunication system. The distributions of source messages and distributions of destination messages can be represented using distribution parameters for one or more families of distributions, histograms, quantiles, summary statistics, and/or other types of values or functions.

In step 404, training engine 122 uses the training data to train a machine learning model to generate a distribution of source messages and a mutual information based on input that includes a corresponding distribution of destination messages. For example, training engine 122 may train a DNN (or another type of machine learning model) to predict, from an inputted distribution of destination messages, a corresponding distribution of source messages paired with the distribution of destination messages in the training data. Training engine 122 may also train the DNN (or machine learning model) to predict the mutual information between the distribution of source messages and the distribution of destination messages.

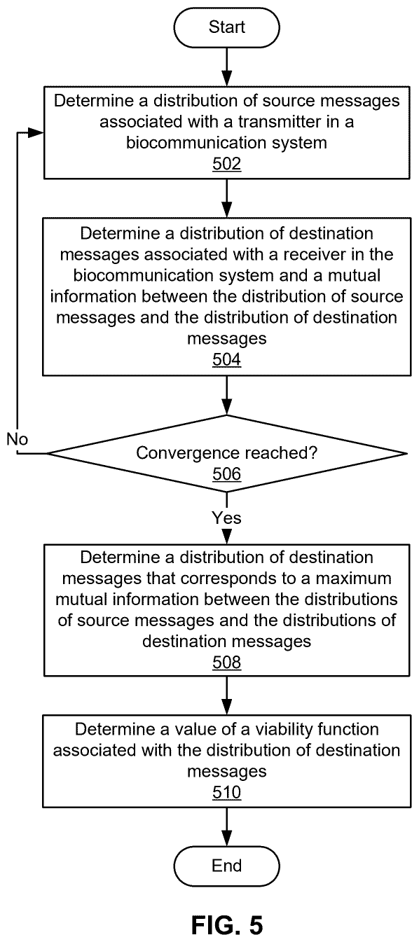

In step 406, execution engine 124 determines a distribution of destination messages that satisfies a viability function. This viability function can quantify a functional integrity, “degree of existence,” and/or another measure of health, performance, or another attribute of interest for the receiver. In some embodiments, step 406 is performed using an information transfer maximization technique that generates the distribution of destination messages in a way that maximizes mutual information values between distributions of the source messages and destination messages, as described in further detail below with respect to FIG. 5. Step 406 can also, or instead, be performed by perturbing a distribution of destination messages that is determined using the information transfer maximization technique and/or otherwise generating a distribution of destination messages that satisfies the viability function.

In step 408, execution engine 124 determines, via execution of the trained machine learning model, a distribution of source messages and a mutual information corresponding to the distribution of destination messages. For example, execution engine 124 may use the trained machine learning model generated in step 404 to estimate the distribution of source messages that results in the distribution of destination messages determined in step 406, as well as the mutual information between the distribution of source messages and the distribution of destination messages.

In step 410, execution engine 124 determines whether or not convergence is reached. For example, steps 406, 408, and 410 could correspond to a hill climbing technique, simulated annealing technique, evolutionary technique, gradient descent technique, and/or another type of optimization technique that seeks to minimize the mutual information between a distribution of source messages and a corresponding distribution of destination messages while maintaining a constant value of the viability function. Convergence could thus correspond to a certain number of iterations of the optimization technique, a difference in mutual information between consecutive iterations that falls below a threshold, and/or another condition.

While convergence is not reached, execution engine 124 repeats steps 406, 408, and 410 to further optimize for mutual information and/or another objective. During each iteration of step 406, execution engine 124 can generate a new distribution of destination messages by perturbing, combining, and/or otherwise changing one or more previously generated distributions of destination messages. Execution engine 124 can then perform step 408 using the trained machine learning model to estimate a distribution of source messages and a mutual information between the distribution of source messages generated in step 408 and the distribution of destination messages generated in step 406. Execution engine 124 can subsequently perform step 410 by determining whether or not convergence has been reached based on the mutual information and/or another value associated with the objective of the optimization technique.

Once execution engine 124 determines that convergence has been reached, execution engine 124 performs step 412, in which execution engine 124 determines a distribution of source messages associated with a minimum mutual information value. For example, execution engine 124 may select, from multiple distributions of source messages and multiple corresponding mutual information values generated over multiple iterations of steps 406, 408, and 410, a distribution of source messages that is associated with the lowest mutual information value in the set of mutual information values.

In step 414, execution engine 124 causes a source message sampled from the determined distribution to be transmitted from the transmitter to the receiver. For example, execution engine 124 may construct a biocommunication system that utilizes samples from the determined distribution to optimize for efficiency between the transmitter and receiver. Execution engine 124 may also, or instead, use the determined distribution to perform experiments and/or interventions involving the biocommunication system.

FIG. 5 sets forth a flow diagram of method steps for performing information transfer maximization in a biocommunication system, according to various embodiments. Although the method steps are described in conjunction with the systems of FIGS. 1-5, persons skilled in the art will understand that any system configured to perform some or all of the method steps in any order falls within the scope of the present disclosure.

In step 502, execution engine 124 determines a distribution of source messages associated with a transmitter in the biocommunication system. For example, execution engine 124 may generate and/or select parameters used to parameterize the distribution of source messages, a histogram representing the distribution of source messages, quantiles and/or summary statistics for the distribution of source messages, and/or another representation of the distribution of source messages.

In step 504, execution engine 124 determines a distribution of destination messages associated with a receiver in the biocommunication system and a mutual information between the distribution of source messages and the distribution of destination messages. For example, execution engine 124 may use a DNN (or another type of machine learning model) to estimate, based on input that includes the distribution of source messages, the distribution of destination messages resulting from the distribution of source messages and the mutual information between the distribution of source messages and the distribution of destination messages.

In step 506, execution engine 124 determines whether or not convergence is reached. For example, steps 502, 504, and 506 may be performed via a hill climbing technique, simulated annealing technique, evolutionary technique, gradient descent technique, and/or another type of optimization technique that seeks to maximize the mutual information between the distribution of source messages and the distribution of destination messages. Convergence may thus correspond to a certain number of iterations of the optimization technique, a difference in mutual information between consecutive iterations that falls below a threshold, and/or another condition.

While convergence is not reached, execution engine 124 repeats steps 502, 504, and 506 to further optimize for mutual information and/or another objective. During each iteration of step 502, execution engine 124 can generate a new distribution of source messages by perturbing, combining, and/or otherwise changing one or more previously generated distributions of source messages. For example, execution engine 124 may generate the new distribution of source messages as a sum of the distribution of source messages generated in a previous iteration and a scaled gradient of the mutual information with respect to the distribution of source messages generated in the previous iteration. Execution engine 124 may also, or instead, generate the new distribution of source messages by randomizing distribution parameters, quantiles, and/or other values representing the new distribution of source messages. Execution engine 124 can then perform step 504 using a machine learning model to estimate a distribution of destination messages and a mutual information between the distribution of source messages generated in step 502 and the distribution of destination messages generated in step 504. Execution engine 124 can subsequently perform step 506 by determining whether or not convergence has been reached based on the mutual information and/or another value associated with the objective of the optimization technique.

Once execution engine 124 determines that convergence has been reached, execution engine 124 performs step 508, in which execution engine 124 determines a distribution of destination messages that corresponds to a maximum mutual information between the distributions of source messages and the distributions of destination messages. For example, execution engine 124 could select, from multiple distributions of destination messages and multiple corresponding mutual information values generated over multiple iterations of steps 502, 504, and 506, a distribution of destination messages that is associated with the highest mutual information in the set of mutual information values.

In step 510, execution engine 124 determines a value of a viability function associated with the distribution of destination messages. For example, execution engine 124 could compute the value as an entropy associated with the distribution of destination messages that corresponds to the maximum mutual information. Execution engine 124 could also, or instead, compute the value of the viability function as a difference in gene expression, chromatin structure, and/or another condition to be maintained or optimized in the biocommunication system. The distribution of destination messages and viability function determined in steps 508 and 510 can then be used to perform semantic optimization in the biocommunication system, as discussed above.

### Example Use Cases

In the first example use case, reverse transfer model 204 includes a DNN that takes as input an n-dimensional vector P(Y), where n is the number of bins in the histogram corresponding to Pₘₐₓ(Y). A shared intermediate FFN encoder is applied to this input to maintain consistency between the two predicted variables (e.g., source message distribution 244 and mutual information 242) and the input variable (e.g., destination message distribution 240). More specifically, the DNN embeds the input distribution P(X) into a hidden representation hᵢₙₜₑᵣₘ through a series of fully connected layers and two separate heads that output P(X) (as an n-dimensional vector) and I(X,Y) (as a scalar), respectively. As ΣₓP(x)=1 and P(X),I(X,Y)≥0 by definition, the space of both outputs is further constrained by (1) applying a final softplus activation to ensure positiveness and (2) normalizing the final logits as

$$P ( X ) = \frac{{h}_{P ( X )}}{\sum {h}_{P ( X )}} ,$$

with h_{P(X)} being the final logits.

In-silico experiments 304 are run to generate 50,000 (P(X), P(Y)) samples to train reverse transfer model 204 using a mixture of random Beta-Binomial distributions (which are also used for the CMA-ES-based information transfer maximization technique described above) and random discrete distributions on the same support (to further regularize the model, providing a more diverse training set). This training technique addresses the initialization of the semantic optimization process necessarily with a distribution P(Y) corresponding to an input distribution in the parametric family B(a, b). As the semantic optimization progresses, P(Y) gradually assumes different forms. Therefore, training data 214 is optimized to improve model robustness in all conditions.

Rectified linear unit (ReLU) activations are used after each linear layer of the DNN corresponding to reverse transfer model 204, and the DNN is trained using an MSE loss. Reverse transfer model 204 is trained for 200 epochs using gradient-based optimization with an Adam optimizer and early stopping. This reverse transfer model 204 includes several hyperparameters, which are optimized on a holdout validation set: learning rate, number of fully connected layers for hᵢₙₜₑᵣₘ, number of neurons for each layer, and β, which controls the relative weight of the two output tasks in the model's loss. The performance of reverse transfer model 204 is evaluated on the test set, resulting in an MSE comparable to the training MSE of ≈6.7×10⁻⁰⁵. Random test distributions are qualitatively inspected, showing that the DNN has accurately learned the system behavior across all tested conditions. The trained reverse transfer model 204 can then be used to efficiently evaluate arbitrary distributions within the iterative semantic optimization technique described above.

A second example use case involves the utilization of real-world data to understand the optimization of communication processes in natural systems. In the second example use case, paired microarray transcriptomics and deoxyribonucleic acid (DNA) methylation data from in-vitro and/or in-vivo experiments 306 provide information about the average abundance levels of transcripts and epigenetic states of the DNA, offering a unified perspective of gene expression and methylation differences between samples. The data is processed to pair each Probe ID (e.g., a unique identifier for a transcript) with the corresponding CpG sites (e.g., regions of DNA that may undergo methylation).

Modification of specific CpG sites may cause DNA to tightly coil into dense “heterochromatin regions” where gene expression is attenuated. More open “euchromatin regions” of demethylated DNA are characterized by higher levels of gene expression. Environmental changes may also trigger DNA modifications, effectively activating different sets of genes. Thus, the relationship between DNA methylation and gene expression can be modeled as a biocommunication system.

In this context, the input variable X represents each CpG site's methylation level, while the corresponding output variable Y represents the gene expression level. The data is structured as a set of probability matrices. Rows represent unique CpG sites, and columns represent Probe IDs. For each of the N=1202 samples, a joint probability matrix with dimensionality [M, K]=[11203,3093] is computed from paired data 302 (x, y). Given both the joint probability distribution P(X, Y) and marginal distributions P(X), P(Y), the conditional probability P(X|Y) is calculated using Bayes' rule. This information is used to evaluate I(X, Y) for each of the N samples.

A higher probability associated with a specific x value indicates a more methylated state for the corresponding CpG site, suggesting a potential role in optimizing communication processes. At the same time, a higher y probability represents a higher expression level for the corresponding Probe ID. This stage of data processing is used to produce N triplets (P(X), P(Y), I(X,Y)), whose elements have dimensionality [M, 1], [K, 1], and [1,1], respectively.

The high dimensionality of both X and Y can present challenges for subsequent analyses. To address this, Principal Component Analysis (PCA) is performed separately on each variable to determine how many components are needed to represent both distributions' support effectively. In this specific use case, selecting the first 20 principal components explains 65% of the variance in X and 86% of the variance in Y. The primary source of variability that requires explanation is associated with the outcome variable Y. The methylation data and the selection of CpG sites introduce noise, since not all CpG sites exert an influence on gene expression. The average mutual information across the N samples is 10.12 bits/symbol.

Because the goal of the second example use case is to understand a biocommunication system, information transfer maximization module 216 operates without imposing a predefined parametric family of distributions to restrict the optimization space, as this restriction would introduce unrealistic shapes that do not naturally occur in the biocommunication system. Further, continuous, high-dimensional optimization becomes intractable for search-based, derivative-free methods. Therefore, information transfer maximization module 216 uses a gradient-based approach to optimize an initial distribution by leveraging gradient information in the mutual information landscape.

Specifically, training engine 122 trains forward transfer model 202 as a DNN with parameters θ to predict P(Y) and I(X, Y) given the input P(X). The DNN includes an architecture and loss function that is similar to the DNN corresponding to reverse transfer model 204 described above with respect to the first example use case. Information transfer maximization module 216 then uses the trained forward transfer model 202 to perform gradient ascent that optimizes P(X) to maximize I(X, Y). The gradient of I(X, Y) with respect to P(X) is efficiently computed through “latent inceptionism” backpropagation, which allows tractable gradients to be computed without introducing assumptions about the underlying system (e.g., a predefined statistical model of the noise).

More specifically, the gradient ascent technique is used to optimize source message distribution 220 P(X) in a way that maximizes mutual information 222 I(X, Y) over a number of iterations. For each iteration of the optimization, P(X) is inputted into the trained forward transfer model 202 to obtain the output I(X, Y). The gradient

$$\frac{\partial MI}{\partial P ( X )}$$

is computed via backpropagation and points in the direction of the steepest ascent, which indicates how changes in P(X) affect the output I(X, Y). To increase I(X,Y), P(X) is updated by adding the computed gradient multiplied by a fixed learning rate. This process is repeated iteratively until the output I(X, Y) is maximized. The maximized mutual information 222 Iₘₐₓ(X, Y) and corresponding source message distribution 220 Pₘₐₓ(X) and destination message distribution 224 Pₘₐₓ(Y) are used as the output of information transfer maximization module 216, and Pₘₐₓ(Y) is used to evaluate Hₘₐₓ(Y).

Training engine 122 also trains reverse transfer model 204 with the same architecture as forward transfer model 202 to predict (P(Y), I(X,Y)) based on P(X). Semantic optimization module 218 uses the trained reverse transfer model 204 with a hill climbing technique to determine the minimum amount of information needed to maintain H(Y)=Hₘₐₓ(Y). The result of the hill climbing technique is obtained as I_{semantic}(X, Y), along with the corresponding P_{semantic}(X).

A third example use case involves dosage curve refinement with an objective to avoid higher unwarranted doses of drugs. Based on multiple experiments 304 and/or 306, a set of drug dosage distributions is paired with a corresponding set of measured responses to a drug. Using this paired data 302, training engine 122 and execution engine 124 can identify semantic information as the minimum drug dosage that would generate the desired effect. This approach reduces the amount of detailed modeling and intrusive data collection (e.g., values related to the Absorption, Distribution, Metabolism, and Excretion (ADME) process) associated with standard approaches in pharmacokinetics. Further, if viability function 238 is related to the production of a specific chemical of industrial interest (e.g., by defining a relationship in terms of information entropy between key chemical characteristics such as toxicity and the amount of information transferred), semantic information can be used to select among various engineering strategies aimed at reducing the presence of harmful by-products. This technique is versatile and can also be applied to a synthetic biology (SynBio) strategy, such as (but not limited to) partial reprogramming.

A fourth example use case involves the identification of semantic information in medical devices such as pacemakers. In this use case, semantic information can correspond to the minimum electrical pulse to be generated to maintain heart functionality while avoiding other effects to bodily function. This minimum electrical pulse can improve device performance, patient safety, and energy consumption.

A fifth example use case involves extracting key elements to be communicated to the receiver to allow the receiver to perform a task. This use case can be used with wearable health devices that generate large amounts of data to identify the minimal necessary data needed to provide accurate health monitoring, thereby enhancing device efficiency and battery life. This use case can also, or instead, be used to improve genomic data analysis by identifying minimal distributions of gene expression data that retain essential information, which reduces the complexity and computational load associated with studying gene regulation and interactions. For example, the minimum set of methylation sites undergoing change as one ages may be identified to maintain the gene expressions of younger and/or healthier states in cells and/or organisms. This use case can also, or instead, be used to identify key signaling molecules and signal pathways to be monitored, thereby enhancing the understanding of how signals are transmitted within cells and simplifying the study of complex cellular processes. This use case can further be extended to metabolite tracking, where semantic information is used to monitor essential metabolites that reflect the activity of these signaling pathways, thus providing a more comprehensive picture of cellular metabolism and function.

In sum, the disclosed techniques optimize semantic information in a biocommunication system that corresponds to a system of communication within or between biological entities. For example, the disclosed techniques may be used to infer, quantify, and/or improve cellular, genetic, molecular, electrical, tactile, visual, audio, and/or other types of communication pathways involving organelles, cells, tissues, organs, organisms, and/or other biological entities.

More specifically, the disclosed techniques use one or more machine learning models to predict attributes related to source messages associated with a transmitter in the biocommunication system and destination messages associated with a receiver in the biocommunication system. The machine learning model(s) include a forward transfer model that predicts, for an inputted distribution of source messages associated with the transmitter, a corresponding distribution of destination messages associated with the receiver and a mutual information between the distribution of source messages and the distribution of destination messages. The machine learning model(s) also, or instead, include a reverse transfer model that predicts, for an inputted distribution of destination messages associated with the receiver, a corresponding distribution of source messages associated with the transmitter and a mutual information between the distribution of source messages and the distribution of destination messages.

The machine learning model(s) are used to perform different types of optimization related to a mutual information that is computed between a given distribution of sources and a corresponding distribution of destination messages and characterizes the amount of information transmitted between the transmitter and the receiver. First, the forward transfer model is used to perform an information transfer maximization that determines a distribution of source messages that maximizes the mutual information with a corresponding distribution of destination messages. The result of the information transfer maximization is used to compute a viability function that quantifies the functional integrity of the receiver, such as (but not limited to) the ability of the receiver to maintain essential functions, perform an intended role, and/or attain or maintain a certain state.

Next, the reverse transfer model is used to perform semantic optimization that determines a distribution of destination messages that minimizes the mutual information with a corresponding distribution of source messages while maintaining the viability function. This distribution of source messages can then be used to construct a biocommunication system that utilizes samples from the determined distribution to optimize for efficiency between the transmitter and receiver, perform experiments and/or interventions involving the biocommunication system, and/or otherwise conduct and/or manage communication within the biocommunication system.

One technical advantage of the disclosed techniques relative to the prior art is the ability to reduce unnecessary information transmission in a biocommunication system without adversely impacting the functional integrity of the receiver in the biocommunication system. Consequently, the disclosed techniques can be used to reduce redundant communication in the biocommunication system and/or improve the energy efficiency of the biocommunication system, compared with conventional techniques that attempt to maximize the amount of information transferred between a transmitter and a receiver. Another technical advantage of the disclosed techniques is the ability to (i) relate semantic information to the channel capacity of the biocommunication system and (ii) model changes to the state of the receiver and/or changes to the effect of the source messages on the receiver. Accordingly, the disclosed techniques may be used to track, manage, and/or optimize information transfer in the biocommunication system more accurately than conventional approaches that fail to account for the dynamic nature of entities in biocommunication systems and/or relate information transfer to channel capacity in biocommunication systems. These technical advantages provide one or more technological improvements over prior art approaches.

1. A computer-implemented method for managing communication in a biocommunication system, comprising generating a first plurality of distributions of destination messages associated with a receiver in the biocommunication system, generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages, determining a first distribution of source messages that is included in the first plurality of distributions of source messages and is associated with a first mutual information value included in the first plurality of mutual information values, and causing a source message sampled from the first distribution of source messages to be transmitted by the transmitter to the receiver.

2. The computer-implemented method of clause 1, further comprising training the machine learning model using a training dataset that includes (i) a second plurality of distributions of source messages, (ii) a second plurality of distributions of destination messages paired with the second plurality of distributions of source messages, and (iii) a second plurality of mutual information values between the second plurality of distributions of source messages and the second plurality of distributions of destination messages.

3. The computer-implemented method of clause 1 or 2, wherein generating the first plurality of distributions of destination messages comprises: determining a first distribution of destination messages that corresponds to a maximum mutual information between a second plurality of distributions of source messages associated with the transmitter and a second plurality of distributions of destination messages associated with the receiver, and perturbing the first distribution of destination messages to generate the first plurality of distributions of destination messages.

4. The computer-implemented method of any of clauses 1-3, wherein perturbing the first distribution of destination messages comprises shuffling one or more bins included in a histogram corresponding to the first distribution of destination messages.

5. The computer-implemented method of any of clauses 1-4, wherein determining the first distribution of destination messages comprises: performing a set of iterations that generate the second plurality of distributions of destination messages and a second plurality of mutual information values between the second plurality of distributions of destination messages and the second plurality of distributions of source messages, and selecting the first distribution of destination messages from the second plurality of distributions of destination messages based on the second plurality of mutual information values.

6. The computer-implemented method of any of clauses 1-5, wherein the first distribution of source messages is determined over a set of iterations that execute the machine learning model to generate the first plurality of distributions of source messages and the first plurality of mutual information values.

7. The computer-implemented method of any of clauses 1-6, wherein the first mutual information value comprises a minimum value included in the first plurality of mutual information values.

8. The computer-implemented method of any of clauses 1-7, wherein determining the first plurality of distributions of destination messages comprises verifying that each distribution of destination messages included in the first plurality of distributions of destination messages satisfies a viability function associated with the biocommunication system.

9. The computer-implemented method of any of clauses 1-8, wherein the viability function comprises an entropy of the destination messages.

10. The computer-implemented method of any of clauses 1-9, wherein the transmitter comprises a first cell in the biocommunication system and the receiver comprises a second cell in the biocommunication system.

11. One or more non-transitory computer readable media storing instructions that, when executed by one or more processors, cause the one or more processors to perform operations comprising: generating a first plurality of distributions of destination messages associated with a receiver in a biocommunication system, generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages, determining a first distribution of source messages that is included in the first plurality of distributions of source messages and is associated with a first mutual information value included in the first plurality of mutual information values, and causing a source message sampled from the first distribution of source messages to be transmitted by the transmitter to the receiver.

12. The one or more non-transitory computer readable media of clause 11, wherein the operations further comprise training the machine learning model using a training dataset that includes (i) a second plurality of distributions of source messages, (ii) a second plurality of distributions of destination messages paired with the second plurality of distributions of source messages, and (iii) a second plurality of mutual information values between the second plurality of distributions of source messages and the second plurality of distributions of destination messages.

13. The one or more non-transitory computer readable media of clause 11 or 12, wherein generating the first plurality of distributions of destination messages comprises: determining a first distribution of destination messages that corresponds to a maximum mutual information between a second plurality of distributions of source messages associated with the transmitter and a second plurality of distributions of destination messages associated with the receiver, and perturbing the first distribution of destination messages to generate the first plurality of distributions of destination messages.

14. The one or more non-transitory computer readable media of any of clauses 11-13, wherein perturbing the first distribution of destination messages comprises exchanging one or more bins included in a histogram corresponding to the first distribution of destination messages.

15. The one or more non-transitory computer readable media of clauses 11-14, wherein determining the first distribution of destination messages comprises: performing a set of iterations that generate the second plurality of distributions of destination messages and a second plurality of mutual information values between the second plurality of distributions of destination messages and the second plurality of distributions of source messages, and selecting the first distribution of destination messages from the second plurality of distributions of destination messages based on the second plurality of mutual information values.

16. The one or more non-transitory computer readable media of clauses 11-15, wherein the first distribution of source messages is determined over a set of hill-climbing iterations that execute the machine learning model to generate the first plurality of distributions of source messages and the first plurality of mutual information values.

17. The one or more non-transitory computer readable media of clauses 11-16, wherein the first mutual information value comprises a minimum value included in the first plurality of mutual information values.

18. The one or more non-transitory computer readable media of clauses 11-17, wherein determining the first plurality of distributions of destination messages comprises verifying that each distribution of destination messages included in the first plurality of distributions of destination messages satisfies a viability function that quantifies a functional integrity associated with the biocommunication system.

19. The one or more non-transitory computer readable media of clauses 11-18, wherein the machine learning model comprises one or more feedforward neural networks.

20. A system, comprising: one or more memories that store instructions, and one or more processors that are coupled to the one or more memories and, when executing the instructions, are configured to perform operations comprising: generating a first plurality of distributions of destination messages associated with a receiver in a biocommunication system; generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages; determining a first distribution of source messages that is included in the first plurality of distributions of source messages and is associated with a minimum mutual information value included in the first plurality of mutual information values; and causing a source message sampled from the first distribution of source messages to be transmitted by the transmitter to the receiver.

21. A computer-implemented method for managing communication in a biocommunication system, comprising: generating a first plurality of distributions of source messages associated with a transmitter in the biocommunication system, determining a first plurality of distributions of destination messages that are associated with a receiver in the biocommunication system and that correspond to the first plurality of distributions of source messages, determining a first distribution of destination messages that corresponds to a maximum mutual information between the first plurality of distributions of source messages and the first plurality of distributions of destination messages, determining a first distribution of source messages associated with the transmitter based on the first distribution of destination messages; and causing a source message sampled from the first distribution of source messages to be transmitted by the transmitter to the receiver.

22. The computer-implemented method of clause 21, wherein determining the first distribution of source messages comprises: generating a second plurality of distributions of destination messages based on the first distribution of destination messages and a viability function, generating, via execution of a machine learning model based on input that includes the second plurality of distributions of destination messages, (i) a second plurality of distributions of source messages associated with the transmitter and (ii) a first plurality of mutual information values between the second plurality of distributions of source messages and the second plurality of distributions of destination messages, and determining, from the second plurality of distributions of source messages, the first distribution of source messages that is associated with a minimum mutual information value included in the first plurality of mutual information values.

23. The computer-implemented method of clause 21 or 22, wherein generating the second plurality of distributions of destination messages comprises determining that the second plurality of distributions of destination messages satisfies a value of the viability function associated with the first distribution of destination messages.

24. The computer-implemented method of any of clauses 21-23, wherein the viability function comprises an entropy associated with the maximum mutual information.

25. The computer-implemented method of any of clauses 21-24, wherein generating the first plurality of distributions of source messages comprises determining one or more distribution parameters used to parameterize the first plurality of distributions of source messages.

26. The computer-implemented method of any of clauses 21-25, wherein: determining the first plurality of distributions of destination messages comprises performing a set of iterations that generate the first plurality of distributions of destination messages and a first plurality of mutual information values between the first plurality of distributions of destination messages and the first plurality of distributions of source messages, and determining the first distribution of destination messages comprises selecting the first distribution of destination messages from the first plurality of distributions of destination messages based on the first plurality of mutual information values.

27. The computer-implemented method of any of clauses 21-26, wherein the first plurality of distributions of destination messages is determined via execution of a machine learning model based on input that includes the first plurality of distributions of source messages.

28. The computer-implemented method of any of clauses 21-27, wherein the first plurality of distributions of destination messages is further determined based on a gradient of a mutual information associated with the first plurality of distributions of destination messages.

29. The computer-implemented method of any of clauses 21-28, wherein the first distribution of destination messages is determined via an optimization technique.

30. The computer-implemented method of any of clauses 21-29, wherein the transmitter is associated with a methylation level and the receiver is associated with a transcript expression level.

31. One or more non-transitory computer readable media storing instructions that, when executed by one or more processors, cause the one or more processors to perform operations comprising: generating a first plurality of distributions of source messages associated with a transmitter in a biocommunication system, determining a first plurality of distributions of destination messages that are associated with a receiver in the biocommunication system and that correspond to the first plurality of distributions of source messages, determining a first distribution of destination messages that corresponds to a maximum mutual information between the first plurality of distributions of source messages and the first plurality of distributions of destination messages, determining a first distribution of source messages associated with the transmitter based on the first distribution of destination messages, and causing a source message sampled from the first distribution of source messages to be transmitted by the transmitter to the receiver.

32. The one or more non-transitory computer readable media of clause 31, wherein determining the first distribution of source messages comprises: generating a second plurality of distributions of destination messages based on the first distribution of destination messages and a viability function, generating, via execution of a machine learning model based on input that includes the second plurality of distributions of destination messages, (i) a second plurality of distributions of source messages associated with the transmitter and (ii) a first plurality of mutual information values between the second plurality of distributions of source messages and the second plurality of distributions of destination messages, and determining, from the second plurality of distributions of source messages, the first distribution of source messages that is associated with a minimum mutual information value included in the first plurality of mutual information values.

33. The one or more non-transitory computer readable media of any of clauses 31-32, wherein generating the second plurality of distributions of destination messages comprises determining that the second plurality of distributions of destination messages satisfies a value of the viability function associated with the first distribution of destination messages.

34. The one or more non-transitory computer readable media of any of clauses 31-33, wherein the viability function comprises an entropy associated with the maximum mutual information.

35. The one or more non-transitory computer readable media of any of clauses 31-35, wherein generating the first plurality of distributions of source messages comprises iteratively updating one or more distribution parameters used to parameterize the first plurality of distributions of source messages.

36. The one or more non-transitory computer readable media of any of clauses 31-36, wherein: determining the first plurality of distributions of destination messages comprises performing a set of gradient ascent iterations that generate the first plurality of distributions of destination messages and a first plurality of mutual information values between the first plurality of distributions of destination messages and the first plurality of distributions of source messages, and determining the first distribution of destination messages comprises selecting the first distribution of destination messages from the first plurality of distributions of destination messages based on the first plurality of mutual information values.

37. The one or more non-transitory computer readable media of any of clauses 31-36, wherein the first plurality of distributions of destination messages and the maximum mutual information are determined via execution of a machine learning model based on input that includes the first plurality of distributions of source messages.

38. The one or more non-transitory computer readable media of any of clauses 31-37, wherein the machine learning model comprises one or more feedforward neural networks.

39. The one or more non-transitory computer readable media of any of clauses 31-38, wherein at least one of the transmitter and the receiver comprises a cell, a tissue, an organ, or an organism.

40. A system, comprising: one or more memories that store instructions, and one or more processors that are coupled to the one or more memories and, when executing the instructions, are configured to perform operations comprising: generating a first plurality of distributions of source messages associated with a transmitter in a biocommunication system, determining a first plurality of distributions of destination messages that are associated with a receiver in the biocommunication system and that correspond to the first plurality of distributions of source messages, determining a first distribution of destination messages that corresponds to a maximum mutual information between the first plurality of distributions of source messages and the first plurality of distributions of destination messages, determining a first distribution of source messages associated with the transmitter based on the first distribution of destination messages, and causing a source message sampled from the first distribution of source messages to be transmitted by the transmitter to the receiver.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for managing communication in a biocommunication system, comprising:
generating a first plurality of distributions of destination messages associated with a receiver in the biocommunication system;
generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages;
determining a first distribution of source messages that is included in the first plurality of distributions of source messages and is associated with a first mutual information value included in the first plurality of mutual information values; and
causing a source message sampled from the first distribution of source messages to be transmitted by the transmitter to the receiver.

2. The computer-implemented method of claim 1, further comprising training the machine learning model using a training dataset that includes (i) a second plurality of distributions of source messages, (ii) a second plurality of distributions of destination messages paired with the second plurality of distributions of source messages, and (iii) a second plurality of mutual information values between the second plurality of distributions of source messages and the second plurality of distributions of destination messages.

3. The computer-implemented method of claim 1, wherein generating the first plurality of distributions of destination messages comprises:
determining a first distribution of destination messages that corresponds to a maximum mutual information between a second plurality of distributions of source messages associated with the transmitter and a second plurality of distributions of destination messages associated with the receiver; and
perturbing the first distribution of destination messages to generate the first plurality of distributions of destination messages.

4. The computer-implemented method of claim 3, wherein perturbing the first distribution of destination messages comprises shuffling one or more bins included in a histogram corresponding to the first distribution of destination messages.

5. The computer-implemented method of claim 3, wherein determining the first distribution of destination messages comprises:
performing a set of iterations that generate the second plurality of distributions of destination messages and a second plurality of mutual information values between the second plurality of distributions of destination messages and the second plurality of distributions of source messages; and
selecting the first distribution of destination messages from the second plurality of distributions of destination messages based on the second plurality of mutual information values.

6. The computer-implemented method of claim 1, wherein the first distribution of source messages is determined over a set of iterations that execute the machine learning model to generate the first plurality of distributions of source messages and the first plurality of mutual information values.

7. The computer-implemented method of claim 1, wherein the first mutual information value comprises a minimum value included in the first plurality of mutual information values.

8. The computer-implemented method of claim 1, wherein determining the first plurality of distributions of destination messages comprises verifying that each distribution of destination messages included in the first plurality of distributions of destination messages satisfies a viability function associated with the biocommunication system.

9. The computer-implemented method of claim 8, wherein the viability function comprises an entropy of the destination messages.

10. The computer-implemented method of claim 1, wherein the transmitter comprises a first cell in the biocommunication system and the receiver comprises a second cell in the biocommunication system.

11. One or more non-transitory computer readable media storing instructions that, when executed by one or more processors, cause the one or more processors to perform operations comprising:
generating a first plurality of distributions of destination messages associated with a receiver in a biocommunication system;
generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages;
determining a first distribution of source messages that is included in the first plurality of distributions of source messages and is associated with a first mutual information value included in the first plurality of mutual information values; and
causing a source message sampled from the first distribution of source messages to be transmitted by the transmitter to the receiver.

12. The one or more non-transitory computer readable media of claim 11, wherein the operations further comprise training the machine learning model using a training dataset that includes (i) a second plurality of distributions of source messages, (ii) a second plurality of distributions of destination messages paired with the second plurality of distributions of source messages, and (iii) a second plurality of mutual information values between the second plurality of distributions of source messages and the second plurality of distributions of destination messages.

13. The one or more non-transitory computer readable media of claim 11, wherein generating the first plurality of distributions of destination messages comprises:
determining a first distribution of destination messages that corresponds to a maximum mutual information between a second plurality of distributions of source messages associated with the transmitter and a second plurality of distributions of destination messages associated with the receiver; and
perturbing the first distribution of destination messages to generate the first plurality of distributions of destination messages.

14. The one or more non-transitory computer readable media of claim 13, wherein perturbing the first distribution of destination messages comprises exchanging one or more bins included in a histogram corresponding to the first distribution of destination messages.

15. The one or more non-transitory computer readable media of claim 13, wherein determining the first distribution of destination messages comprises:
performing a set of iterations that generate the second plurality of distributions of destination messages and a second plurality of mutual information values between the second plurality of distributions of destination messages and the second plurality of distributions of source messages; and
selecting the first distribution of destination messages from the second plurality of distributions of destination messages based on the second plurality of mutual information values.

16. The one or more non-transitory computer readable media of claim 11, wherein the first distribution of source messages is determined over a set of hill-climbing iterations that execute the machine learning model to generate the first plurality of distributions of source messages and the first plurality of mutual information values.

17. The one or more non-transitory computer readable media of claim 11, wherein the first mutual information value comprises a minimum value included in the first plurality of mutual information values.

18. The one or more non-transitory computer readable media of claim 11, wherein determining the first plurality of distributions of destination messages comprises verifying that each distribution of destination messages included in the first plurality of distributions of destination messages satisfies a viability function that quantifies a functional integrity associated with the biocommunication system.

19. The one or more non-transitory computer readable media of claim 11, wherein the machine learning model comprises one or more feedforward neural networks.

20. A system, comprising:
one or more memories that store instructions, and
one or more processors that are coupled to the one or more memories and, when executing the instructions, are configured to perform operations comprising:
generating a first plurality of distributions of destination messages associated with a receiver in a biocommunication system;
generating, via execution of a machine learning model based on input that includes the first plurality of distributions of destination messages, (i) a first plurality of distributions of source messages associated with a transmitter in the biocommunication system and (ii) a first plurality of mutual information values between the first plurality of distributions of source messages and the first plurality of distributions of destination messages;
determining a first distribution of source messages that is included in the first plurality of distributions of source messages and is associated with a minimum mutual information value included in the first plurality of mutual information values; and
causing a source message sampled from the first distribution of source messages to be transmitted by the transmitter to the receiver.

21. A computer-implemented method for managing communication in a biocommunication system, comprising:
generating a first plurality of distributions of source messages associated with a transmitter in the biocommunication system;
determining a first plurality of distributions of destination messages that are associated with a receiver in the biocommunication system and that correspond to the first plurality of distributions of source messages;
determining a first distribution of destination messages that corresponds to a maximum mutual information between the first plurality of distributions of source messages and the first plurality of distributions of destination messages;
determining a first distribution of source messages associated with the transmitter based on the first distribution of destination messages; and
causing a source message sampled from the first distribution of source messages to be transmitted by the transmitter to the receiver.

22. The computer-implemented method of claim 21, wherein determining the first distribution of source messages comprises:
generating a second plurality of distributions of destination messages based on the first distribution of destination messages and a viability function;
generating, via execution of a machine learning model based on input that includes the second plurality of distributions of destination messages, (i) a second plurality of distributions of source messages associated with the transmitter and (ii) a first plurality of mutual information values between the second plurality of distributions of source messages and the second plurality of distributions of destination messages; and
determining, from the second plurality of distributions of source messages, the first distribution of source messages that is associated with a minimum mutual information value included in the first plurality of mutual information values.

23. The computer-implemented method of claim 22, wherein generating the second plurality of distributions of destination messages comprises determining that the second plurality of distributions of destination messages satisfies a value of the viability function associated with the first distribution of destination messages.

24. The computer-implemented method of claim 22, wherein the viability function comprises an entropy associated with the maximum mutual information.

25. The computer-implemented method of claim 21, wherein generating the first plurality of distributions of source messages comprises determining one or more distribution parameters used to parameterize the first plurality of distributions of source messages.

26. The computer-implemented method of claim 21, wherein:
determining the first plurality of distributions of destination messages comprises performing a set of iterations that generate the first plurality of distributions of destination messages and a first plurality of mutual information values between the first plurality of distributions of destination messages and the first plurality of distributions of source messages, and
determining the first distribution of destination messages comprises selecting the first distribution of destination messages from the first plurality of distributions of destination messages based on the first plurality of mutual information values.

27. The computer-implemented method of claim 21, wherein the first plurality of distributions of destination messages is determined via execution of a machine learning model based on input that includes the first plurality of distributions of source messages.

28. The computer-implemented method of claim 27, wherein the first plurality of distributions of destination messages is further determined based on a gradient of a mutual information associated with the first plurality of distributions of destination messages.

29. The computer-implemented method of claim 21, wherein the first distribution of destination messages is determined via an optimization technique.

30. The computer-implemented method of claim 21, wherein the transmitter is associated with a methylation level and the receiver is associated with a transcript expression level.

31. One or more non-transitory computer readable media storing instructions that, when executed by one or more processors, cause the one or more processors to perform operations comprising:
generating a first plurality of distributions of source messages associated with a transmitter in a biocommunication system;
determining a first plurality of distributions of destination messages that are associated with a receiver in the biocommunication system and that correspond to the first plurality of distributions of source messages;
determining a first distribution of destination messages that corresponds to a maximum mutual information between the first plurality of distributions of source messages and the first plurality of distributions of destination messages;
determining a first distribution of source messages associated with the transmitter based on the first distribution of destination messages; and
causing a source message sampled from the first distribution of source messages to be transmitted by the transmitter to the receiver.

32. The one or more non-transitory computer readable media of claim 31, wherein determining the first distribution of source messages comprises:
generating a second plurality of distributions of destination messages based on the first distribution of destination messages and a viability function;
generating, via execution of a machine learning model based on input that includes the second plurality of distributions of destination messages, (i) a second plurality of distributions of source messages associated with the transmitter and (ii) a first plurality of mutual information values between the second plurality of distributions of source messages and the second plurality of distributions of destination messages; and
determining, from the second plurality of distributions of source messages, the first distribution of source messages that is associated with a minimum mutual information value included in the first plurality of mutual information values.

33. The one or more non-transitory computer readable media of claim 32, wherein generating the second plurality of distributions of destination messages comprises determining that the second plurality of distributions of destination messages satisfies a value of the viability function associated with the first distribution of destination messages.

34. The one or more non-transitory computer readable media of claim 32, wherein the viability function comprises an entropy associated with the maximum mutual information.

35. The one or more non-transitory computer readable media of claim 31, wherein generating the first plurality of distributions of source messages comprises iteratively updating one or more distribution parameters used to parameterize the first plurality of distributions of source messages.

36. The one or more non-transitory computer readable media of claim 31, wherein:
determining the first plurality of distributions of destination messages comprises performing a set of gradient ascent iterations that generate the first plurality of distributions of destination messages and a first plurality of mutual information values between the first plurality of distributions of destination messages and the first plurality of distributions of source messages, and
determining the first distribution of destination messages comprises selecting the first distribution of destination messages from the first plurality of distributions of destination messages based on the first plurality of mutual information values.

37. The one or more non-transitory computer readable media of claim 31, wherein the first plurality of distributions of destination messages and the maximum mutual information are determined via execution of a machine learning model based on input that includes the first plurality of distributions of source messages.

38. The one or more non-transitory computer readable media of claim 37, wherein the machine learning model comprises one or more feedforward neural networks.

39. The one or more non-transitory computer readable media of claim 31, wherein at least one of the transmitter and the receiver comprises a cell, a tissue, an organ, or an organism.

40. A system, comprising:
one or more memories that store instructions, and
one or more processors that are coupled to the one or more memories and, when executing the instructions, are configured to perform operations comprising:
generating a first plurality of distributions of source messages associated with a transmitter in a biocommunication system;
determining a first plurality of distributions of destination messages that are associated with a receiver in the biocommunication system and that correspond to the first plurality of distributions of source messages;
determining a first distribution of destination messages that corresponds to a maximum mutual information between the first plurality of distributions of source messages and the first plurality of distributions of destination messages;
determining a first distribution of source messages associated with the transmitter based on the first distribution of destination messages; and
causing a source message sampled from the first distribution of source messages to be transmitted by the transmitter to the receiver.
